(19) United States
(12) Patent Application Publication
(10) Pub. No.: US 2009/0303755 A1
(43) Pub. Date: Dec. 10, 2009

(54) POWER CONVERTER APPARATUS

(75) Inventor: Chin-Hsun Hsu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/192,140

(22) Filed: Aug. 15, 2008

(30) Foreign Application Priority Data
Jun. 4, 2008 (TW) 97120794

(51) Int. Cl. H02M 3/335

(52) U.S. Cl. 363/21.06

(57) ABSTRACT

A power converter apparatus for receiving an input voltage and produces an output voltage by converting includes a switching-type voltage converting circuit circuit and a voltage level tuning circuit. The switching-type voltage converting circuit circuit includes an inductor, a switch and a synchronous rectifier, wherein the switch is for disabling/enabling the energy-storing operation conducted by the inductor. The synchronous rectifier produces the output voltage by using the stored electrical energy during the above-mentioned energy-storing operation. Besides, the voltage level tuning circuit is across coupled onto the switch for reducing the voltage difference between the two terminals of the switch.

### CROSS-REFERENCE TO RELATED APPLICATION

This application claims the priority benefit of Taiwan application serial no. 97120794, filed on Jun. 4, 2008. The entirety of the above-mentioned patent application is hereby incorporated by reference herein and made a part of this specification.

### BACKGROUND OF THE INVENTION

1. Field of the Invention

The present invention generally relates to a power converter apparatus, and more particularly, to a DC-to-DC power converter apparatus.

2. Description of Related Art

Along with the progress of electronic technology, the demands of people on electronic products and the relevant products thereof get increasing. In order to provide people with inexpensive but good commodities, a designer of the modern electronic products needs to deal with the important project of saving the volume of an electronic product. In a general electronic device, a plurality of power supplies are usually employed to provide operation voltages. To avoid using a plurality of bulky transformers to provide the power supplies with different voltages, a power converter apparatus as a power supply is most preferred by the designer.

However, a general DC-to-DC power converter apparatus conducts the power conversion by using switches, which inevitably causes a ring phenomenon. FIG. 1A is a circuit diagram of a conventional DC-to-DC power converter apparatus. Referring to FIG. 1A, a power converter apparatus 10 comprises an inductor L1, two switches SW1 and SW2 and two capacitors C1 and C2. When the terminal A receives an input voltage and an output voltage is produced at the terminal B, the power converter apparatus 10 functions as a boost power converter apparatus; in contrast, when the terminal B receives an input voltage and an output voltage is produced at the terminal A, the power converter apparatus 10 functions as a buck power converter apparatus.

No matter the power converter apparatus 10 is served as a boost power converter apparatus or a buck power converter apparatus, after the stored electrical energy of the inductor L1 is completely discharged, the switches SW1 and SW2 would be simultaneously disabled within a period of time to form open-circuits. At the moment entering the above-mentioned states, a so-called ring phenomenon occurs.

FIG. 1B is a diagram showing the voltage/current-time relationships of the voltages of the switches SW1 and SW2, the voltage VC of the terminal C and the current IL1 of the inductor L1 in a buck power converter apparatus. Referring to FIG. 1B, prior to the open-circuit states of the switches SW1 and SW2, the switch SW1 is turned on, and the terminal C, where the inductor L1 and the switch SW1 are coupled to, corresponds to 0 voltage level. After the switch SW1 becomes an open-circuit (entering the interval TR), the terminal A (with a voltage level VA) must charge the terminal C through the inductor L1 so as to make the terminal C reach the same level as the voltage level VA of the terminal A. Thus, within the interval TR, a ring phenomenon occurs. The ring phenomenon corresponding to the voltage/current-time relationships of the voltage VC at the terminal C and the current IL1 flowing through the inductor L1 within the interval TC shown in FIG. 1C.

Similarly, in a boost power converter apparatus, prior to the open-circuit states of the switches SW1 and SW2, the switch SW2 is turned on and the terminal C corresponds to a level equal to that of the terminal B. After the switch SW2 becomes an open-circuit, the terminal C must discharge the energy thereof to the terminal A through the inductor L1, which causes a ring phenomenon occurs as well.

The above-mentioned ring phenomenon produces additional noises and electromagnetic interferences (EMI). Therefore, in some power converter apparatuses required with higher specification, a short-circuit between the two ends of the inductor L1 is formed when both the switches SW1 and SW2 become open-circuits, so that the above-mentioned charging and discharging operations do not cause the ring phenomenon through the inductor L1. However, the above-mentioned scheme has a disadvantage in designing a circuit implemented with a chip that additional pins connected to the terminal A need to be employed, which wastes the circuit area.

### SUMMARY OF THE INVENTION

Accordingly, the present invention is directed to a power converter apparatus capable of effectively reducing the ring phenomenon during converting powers.

The present invention provides a power converter apparatus for receiving an input voltage and producing an output voltage. The power converter apparatus includes a switching-type voltage converting circuit and a voltage level tuning circuit. The switching-type voltage converting circuit includes an inductor, a switch and a synchronous rectifier, wherein the switch is for disabling/enabling the inductor to conduct energy-storing operations, and the synchronous rectifier produces the output voltage by using the stored electrical energy produced during the above-mentioned energy-storing operation. In addition, the voltage level tuning circuit is across connected onto the switch for reducing the voltage difference between the two terminals of the switch.

Since the present invention adopts the structure of a voltage level tuning circuit; therefore, the present invention is able effectively and respectively to conduct a pre-charging operation on the buck voltage converting circuit and a pre-discharging operation on the boost voltage converting circuit so as to effectively suppress the ring phenomenon.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a circuit diagram of a conventional DC-to-DC power converter apparatus.

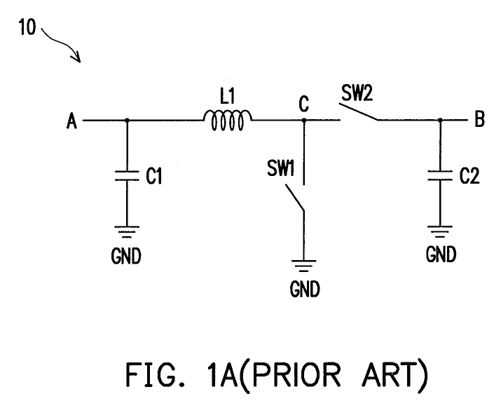

FIG. 1B is a diagram showing the voltage/current-time relationships of the voltages of the switches SW1 and SW2, the voltage VC of the terminal C and the current IL1 of the inductor L1 in FIG. 1A.

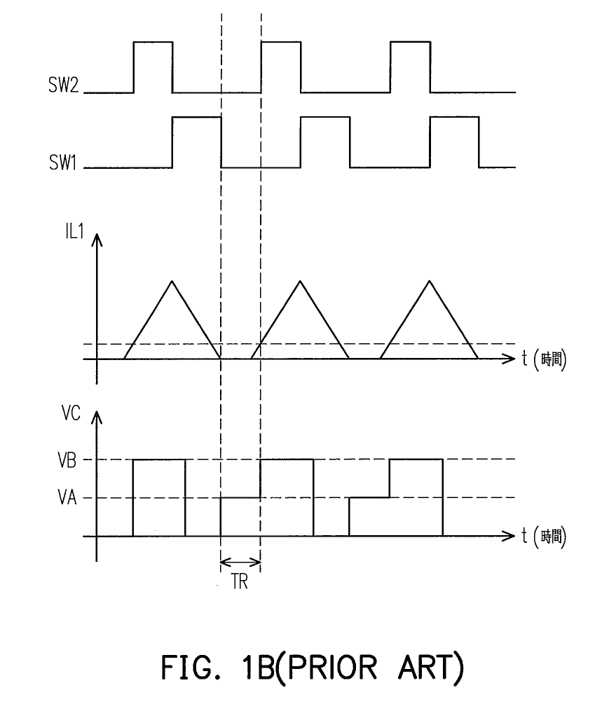

FIG. 1C is a diagram showing the voltage/current-time relationships of the voltage VC of the terminal C and the current IL1 of the inductor L1 in FIG. 1A within the interval TR.

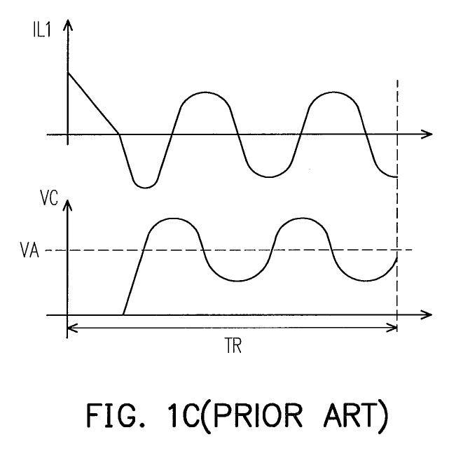

FIG. 2A is a circuit diagram of a power converter apparatus according to the first embodiment of the present invention.

FIGS. 2B-2D are circuit diagrams of the power converter apparatus 20 with different implementations of the voltage level tuning circuit 220.

FIG. 3A is a circuit diagram of a power converter apparatus according to the second embodiment of the present invention.

FIGS. 3B-3D are circuit diagrams of the power converter apparatus 30 with different implementations of the voltage level tuning circuit 320.

### DESCRIPTION OF THE EMBODIMENTS

Reference will now be made in detail to the power converter apparatus of the present invention through a plurality of embodiments and a plurality of implementation methods, the examples of which are illustrated in the accompanying drawings. Wherever possible, the same reference numbers are used in the drawings and the description to refer to the same or like parts.

### The First Embodiment

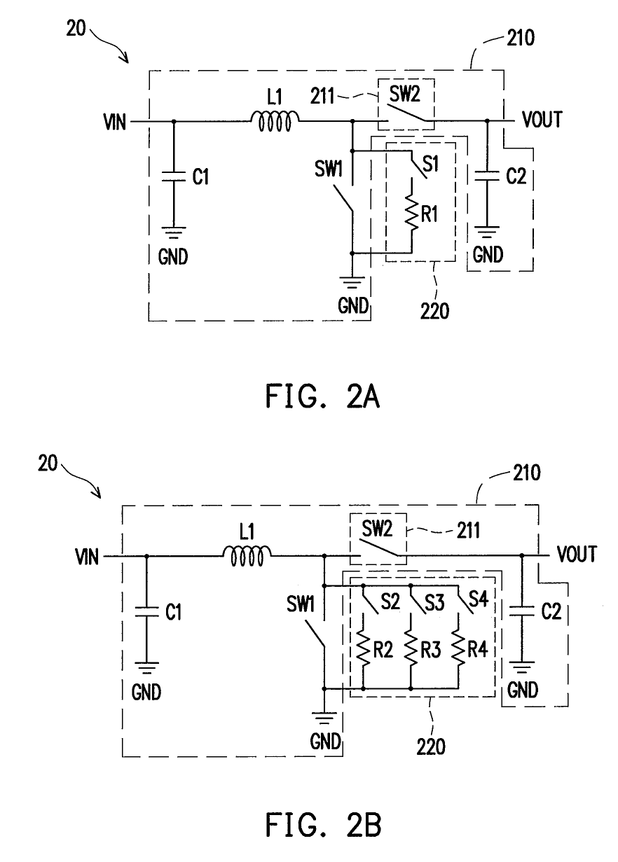

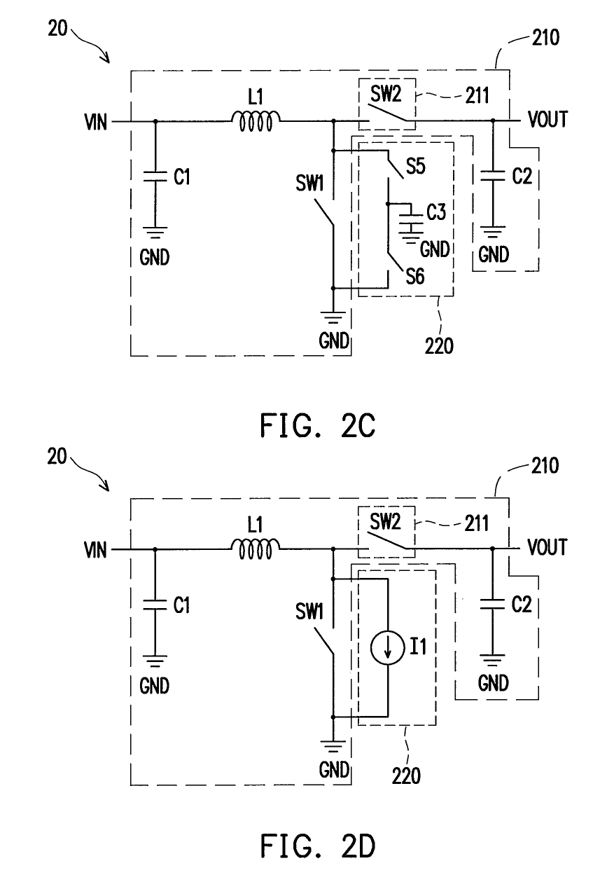

Referring to FIG. 2A, it is a circuit diagram of a power converter apparatus according to the first embodiment of the present invention. The power converter apparatus 20 herein is a boost power converter apparatus, which includes a switching-type voltage converting circuit 210 and a voltage level tuning circuit 220. The switching-type voltage converting circuit 210 includes an inductor L1, a regulating capacitor C1, a storage capacitor C2, a switch SW1 and a synchronous rectifier 211, wherein an end of the inductor L1 receives an input voltage VIN; the switch SW1 is connected in series between the other end of the inductor L1 and a grounded voltage GND; a terminal of the synchronous rectifier 211, the other end of the inductor L1 and the switch SW1 are coupled to each other; the other terminal of the synchronous rectifier 211 produces an output voltage VOUT. The synchronous rectifier 211 is composed of a rectifying switch SW2.

In terms of the overall operation of the power converter apparatus 20, first, the switch SW1 is enabled (turned on) and the rectifying switch SW2 is disabled (open-circuit), so that the inductor L1 receives the input voltage VIN to conduct an energy-storing operation; second, the switch SW1 is disabled and the rectifying switch SW2 is enabled. At the time, the stored electrical energy in the inductor L1 charges the storage capacitor C2 via the rectifying switch SW2 to boost the output voltage VOUT.

Then, the rectifying switch SW2 is disabled, and at the time, the level of the end of the inductor L1 coupled to the rectifying switch SW2 is decreased by discharging and finally equal to the input voltage VIN. To smoothly conduct the discharging operation to avoid the ring phenomenon, the voltage level tuning circuit 220 is meanwhile started. The voltage level tuning circuit 220 is connected at both terminals of the switch SW1. In the first embodiment, the voltage level tuning circuit 220 includes an adjustment switch S1 and a resistor R1. When the voltage level tuning circuit 220 is started, the adjustment switch S1 is enabled, and the voltage level of the end, where inductor L1 is coupled to the rectifying switch SW2, is decreased by a pre-discharging operation conducted by the adjustment switch S1 and the resistor R1 so as to reduce the ring phenomenon.

Note that the resistor R1 can be implemented by a variable resistor. When the voltage difference between the two terminals of the switch SW1 is considerably larger, the resistor R1 has a smaller resistance by adjusting so as to make discharging in a quicker rate. Along with decreasing the voltage difference between the two terminals of the switch SW1 due to discharging, the resistance of the resistor R1 can be gradually increased by adjusting so as to avoid downgrading the efficiency of the power converter apparatus due to additional discharge.

In addition, the voltage level tuning circuit 220 can be implemented by different ways. Referring to FIG. 2B, it is a circuit diagram of the power converter apparatus 20 with another voltage level tuning circuit 220. In the implementation, the voltage level tuning circuit 220 comprises a plurality of adjustment switches S2, S3 and S4 and a plurality of resistors R2, R3 and R4. A terminal of each of the adjustment switches S2, S3 and S4 is together coupled to a terminal of the switch SW1, an end of each of the resistors R2, R3 and R4 is respectively coupled to the other terminals of the adjustment switches S2, S3 and S4, and the other ends of the resistors R2, R3 and R4 are together coupled to the other terminal of the switch SW1.

With the above-mentioned implementation of the voltage level tuning circuit 220, in beginning a pre-discharging operation, all the adjustment switches S2, S3 and S4 are turned on. During discharging, the adjustment switches S2, S3 and S4 are sequentially turned off one by one until all the adjustment switches S2, S3 and S4 are turned off, where the pre-discharging operation is completed. With the scheme by using the plurality of resistors in parallel connection, the larger the number of the resistors in parallel connection, the more smoothly the produced resistance is changed during turning off the adjustment switches. In other words, with the above-mentioned scheme, the produced discharge current during discharging is changed more smoothly.

The above-mentioned implementation by using three sets of the adjustment switches S2, S3 and S4 and the resistors R2, R3 and R4 is one of the implementations only. In the other implementations, more sets of the adjustment switches and the resistors (i.e., greater than three sets) or fewer sets of the adjustment switches and the resistors (i.e., two sets) are allowed to implement the voltage level tuning circuit 220, which the present invention is not limited to.

In the following, another implementation of the voltage level tuning circuit is provided. Referring to FIG. 2C, it is a circuit diagram of the power converter apparatus 20 with yet another voltage level tuning circuit 220. In the implementation, the voltage level tuning circuit 220 is implemented by using a switching capacitor. A terminal of a switch S5 herein is coupled to a terminal of the switch SW1, a terminal of a switch S6 is coupled to the other terminal of the switch SW1, a terminal of a capacitor C3 is coupled to both the other terminal of the switch S5 and the other terminal of the switch S6, and the other terminal of the capacitor C3 is coupled to the grounded voltage GND, wherein the switch S5 and the switch S6 are disabled or enabled in inverting manners to each other.

The voltage level tuning circuit 220 utilizes the continuously-inverting switches S5 and S6 in corporation with the capacitor C3 to form an equivalent resistor, where the equivalent resistance is equal to 1/(C3*f_{sw}) and f_{sw} is the switching frequency of the switches S5 and S6. That is to say, by changing the switching frequency of the switches S5 and S6, the equivalent resistance of the voltage level tuning circuit 220 is controlled, which further controls the pre-discharging current and the discharging speed.

Referring to FIG. 2D, it is a circuit diagram of the power converter apparatus 20 with yet another voltage level tuning circuit 220. In the implementation, the voltage level tuning circuit 220 is implemented by using a voltage-controlled current source I1. The voltage-controlled current source I1 is connected to both terminals of the switch SW1. A balance current of the voltage-controlled current source I1 is produced according to the voltage difference between the two terminals of the switch SW1 while the switch SW1 and the synchronous rectifier 211 become open-circuit, and the balance current is used to conduct the pre-discharging operation to reduce the voltage difference between the two terminals of the switch SW1 and further reduce the ring phenomenon. In addition, the voltage-controlled current source I1 can be composed of a transistor as well. The implementation of the voltage-controlled current source I1 by using the transistor can be easily understood by anyone skilled in the art, which is omitted for simplicity.

Similarly, the present invention can control the balance current of the voltage-controlled current source I1. For example, when the voltage difference between the two terminals of the switch SW1 is considerably larger, the voltage-controlled current source I1 outputs a larger balance current to quickly discharge; along with the voltage difference between the two terminals of the switch SW1 is gradually decreased due to discharging, the voltage-controlled current source I1 outputs a smaller balance current by gradually adjusting so as to avoid degrading the efficiency of the power converter apparatus due to additional discharge.

Note that in the first embodiment and the various implementations of the voltage level tuning circuit 220 thereof, the synchronous rectifier 211 is composed of a rectifying switch SW2; and the various above-mentioned switches (including the switch SW1, the rectifying switch SW2, the adjustment switches S1-S4 and the switches S5 and S6) can be respectively implemented with a transistor, wherein the gate voltage of each transistor is controlled to enable or disable the switches. The implementations of the switches by using the transistors can be easily understood by anyone skilled in the art, which is omitted for simplicity.

### The Second Embodiment

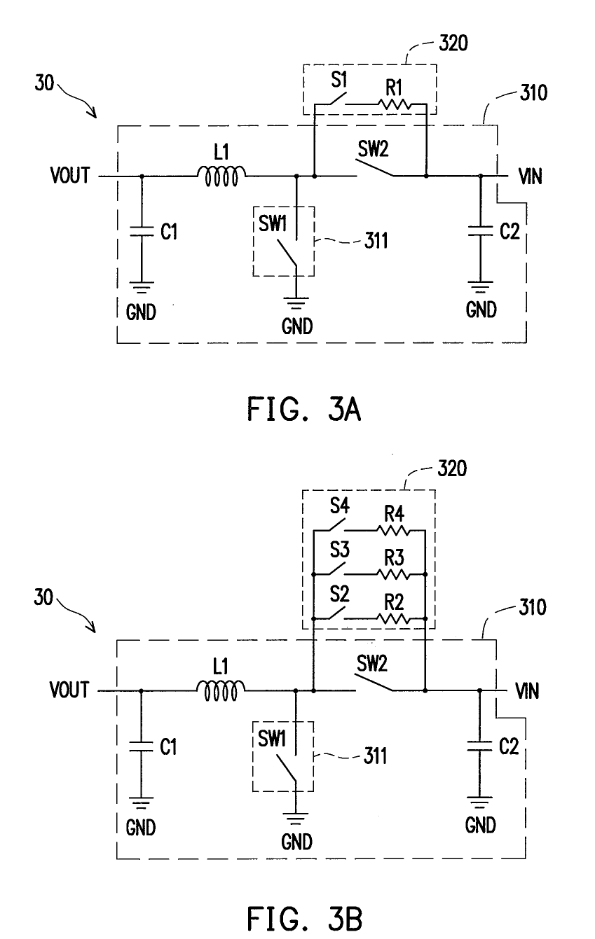

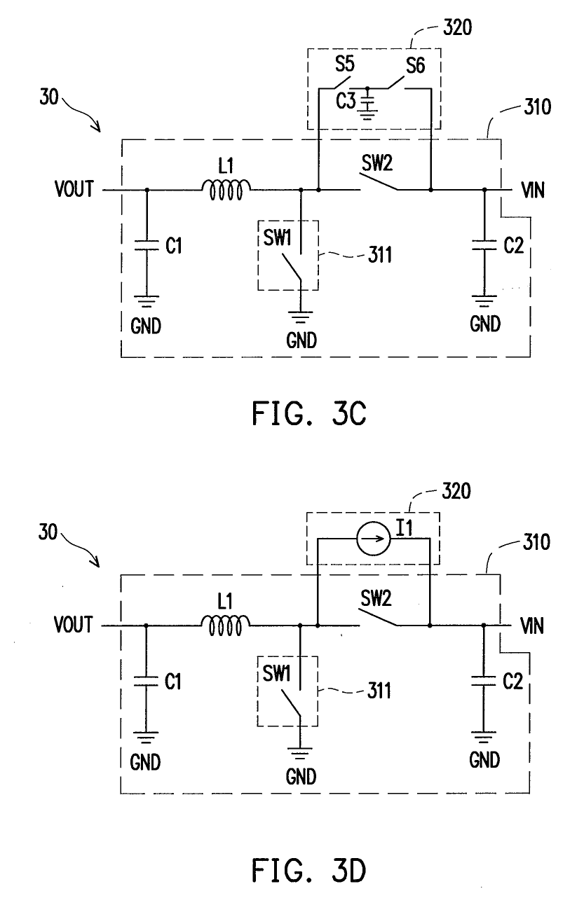

FIG. 3A is a circuit diagram of a power converter apparatus according to the second embodiment of the present invention. Referring to FIG. 3A, the power converter apparatus 30 herein is a buck power converter apparatus, which includes a switching-type voltage converting circuit 310 and a voltage level tuning circuit 320. The switching-type voltage converting circuit 310 includes an inductor L1, a regulating capacitor C2, a storage capacitor C1, a switch SW2 and a synchronous rectifier 311, wherein a terminal of the switch SW2 receives the input voltage VIN, the other terminal of the switch SW2 is coupled to an end of the inductor L1 and the other end of the inductor L1 produces the output voltage VOUT. In addition, a terminal of the synchronous rectifier 311 is coupled to both an end of the inductor L1 and the other terminal of the switch SW2, the other terminal of the synchronous rectifier 311 is coupled to the grounded voltage GND and the synchronous rectifier 311 is composed of a rectifying switch SW1.

In terms of the overall operation of the power converter apparatus 30, first, the switch SW2 is enabled (turned on) and the rectifying switch SW1 is disabled (open-circuit), so that the inductor L1 receives the input voltage VIN via the switch SW2 to conduct an energy-storing operation; second, the switch SW2 is disabled and the rectifying switch SW1 is enabled. At the time, the stored electrical energy in the inductor L1 is discharged to produce a current flowing from the grounded voltage GND to the storage capacitor C1 via the rectifying switch SW1 to reduce the output voltage VOUT.

Then, the rectifying switch SW1 is disabled, and at the time, the voltage level of the end where the inductor L1 is coupled to the rectifying switch SW1 is increased by charging and finally equal to the output voltage VOUT. To smoothly conduct the charging operation to avoid the ring phenomenon, the voltage level tuning circuit 320 is meanwhile started. The voltage level tuning circuit 320 is connected at both terminals of the switch SW2. Similarly to the first embodiment, the voltage level tuning circuit 320 in the second embodiment includes an adjustment switch S1 and a resistor R1. When the voltage level tuning circuit 320 is started, the adjustment switch S1 is disabled, and the level of the end of the inductor L1 coupled to the rectifying switch SW1 is increased by a pre-charging operation conducted by the adjustment switch S1 and the resistor R1 so as to reduce the ring phenomenon.

In addition, similarly to the first embodiment, the voltage level tuning circuit 320 in the second embodiment can be implemented by different ways. FIGS. 3B-3D are circuit diagrams of the power converter apparatus 30 with different implementations of the voltage level tuning circuit 320.

Referring to FIG. 3B, the voltage level tuning circuit 320 comprises a plurality of switches S2-S4 and a plurality of resistors R2-R4 respectively connected in series to the voltage level tuning circuit 320. The voltage level tuning circuit 320 in FIG. 3C is implemented by a so-called switching capacitor. The voltage level tuning circuit 320 in FIG. 3D is implemented by a voltage-controlled current source I1. The operations of the above-mentioned voltage level tuning circuits 320 in different implementations are the same as that in the first embodiment, except that the voltage level tuning circuit 220 in the first embodiment conducts a pre-discharging operation, and the voltage level tuning circuit 320 in the second embodiment conducts a pre-charging operation. For this reason, the operation details of the voltage level tuning circuit 320 are omitted for simplicity.

In summary, the present invention utilizes a voltage level tuning circuit to conduct the corresponding pre-charging operation or pre-discharging operation on the power converter apparatus, wherein the voltage level tuning circuit conducts the charging and discharging operations without an inductor, and no need to employ extra pins in designing a circuit implemented with a chip. The present invention thereby can effectively reduce the ring phenomenon without increasing the circuit area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power converter apparatus, suitable for receiving an input voltage and converting the input voltage to generate an output voltage; the apparatus comprising:
a switching-type voltage converting circuit comprising an inductor, a switch and a synchronous rectifier, wherein the switch is for disabling or enabling the inductor to conduct an energy-storing operation, and the synchronous rectifier produces the output voltage by using the stored electrical energy produced during the energy-storing operation; and
a voltage level tuning circuit, across connected onto the switch for reducing the voltage difference between the two terminals of the switch.

2. The power converter apparatus according to claim 1, wherein when both the switch and the synchronous rectifier become open-circuits, the voltage level tuning circuit reduces the voltage difference between the two terminals of the switch.

3. The power converter apparatus according to claim 2, wherein the voltage level tuning circuit comprises:
a first adjustment switch, coupled to a terminal of the switch; and
a first resistor, connected in series between the first adjustment switch and the other terminal of the switch;
wherein when both the switch and the synchronous rectifier become open-circuits, the first adjustment switch is enabled so that the voltage level tuning circuit adjusts and reduces the voltage difference between the two terminals of the switch by using the first resistor.

4. The power converter apparatus according to claim 3, wherein the first resistor is a variable resistor, and the resistance of the first resistor is varied with the voltage difference between the two terminals of the switch.

5. The power converter apparatus according to claim 2, wherein the voltage level tuning circuit comprises:
a plurality of second adjustment switches, together coupled to a terminal of the switch; and
a plurality of second resistors, respectively connected in series between the second adjustment switches and the other terminal of the switch;
wherein when both the switch and the synchronous rectifier become open-circuits, the second adjustment switches are respectively enabled, so that the voltage level tuning circuit adjusts and reduces the voltage difference between the two terminals of the switch by using the corresponding second resistors.

6. The power converter apparatus according to claim 5, wherein the equivalent resistance of the second resistors are varied with the voltage difference between the two terminals of the switch.

7. The power converter apparatus according to claim 2, wherein the voltage level tuning circuit comprise:
a first switch having a terminal coupled to a terminal of the switch;
a second switch having a terminal coupled to the other terminal of the switch; and
a capacitor having a first terminal coupled to both the other terminal of the first switch and a second terminal coupled to a grounded voltage;
wherein the first switch and the second switch are disabled or enabled in
inverting manners to each other, and when both the switch and the synchronous rectifier become open-circuits, the first switch and the second switch are continuously switched in a switching frequency so that the voltage level tuning circuit adjusts and reduces the voltage difference between the two terminals of the switch.

8. The power converter apparatus according to claim 7, wherein switching frequencies of the first switch and the second switch are varied with the voltage difference between the two terminals of the switch, so that the equivalent impedance of the capacitor is varied with the voltage difference between the two terminals of the switch.

9. The power converter apparatus according to claim 2, wherein the voltage level tuning circuit comprises:
a voltage-controlled current source, connected in series between a terminal and the other terminal of the switch for producing a balancing current when both the switch and the synchronous rectifier become open-circuits.

10. The power converter apparatus according to claim 9, wherein the balancing current output from the voltage-controlled current source is varied with the voltage difference between the two terminals of the switch.

11. The power converter apparatus according to claim 1, wherein the switching-type voltage converting circuit is a boost voltage converting circuit.

12. The power converter apparatus according to claim 11, wherein an end of the inductor receives the input voltage, and the switch is connected in series between the other end of the inductor and a grounded voltage; a terminal of the synchronous rectifier, the other end of the inductor and the switch are coupled to each other, and the other terminal of the synchronous rectifier produces the output voltage.

13. The power converter apparatus according to claim 12, further comprising:
a storage capacitor coupled between the other terminal of the synchronous rectifier and the grounded voltage.

14. The power converter apparatus according to claim 12, further comprising:
a regulating capacitor coupled between an end of the inductor receiving the input voltage and the grounded voltage.

15. The power converter apparatus according to claim 1, wherein the switching-type voltage converting circuit is a buck voltage converting circuit.

16. The power converter apparatus according to claim 15, wherein a terminal of the switch receives the input voltage and the other terminal of the switch is coupled to an end of the inductor, the other end of the inductor produces the output voltage; a terminal of the synchronous rectifier, an end of the inductor and the other terminal of the switch are coupled to each other; the other terminal of the synchronous rectifier is coupled to the grounded voltage.

17. The power converter apparatus according to claim 16, further comprising:
a storage capacitor coupled between the other end of the inductor and the grounded voltage.

18. The power converter apparatus according to claim 16, further comprising:
a regulating capacitor coupled between an end of the inductor receiving the input voltage and the grounded voltage.

19. The power converter apparatus according to claim 1, wherein the synchronous rectifier comprises a rectifying switch.
